(19) United States
(12) Patent Application Publication
(10) Pub. No.: US 2003/0017857 A1
(43) Pub. Date: Jan. 23, 2003

(54) Wireless device local access system

(76) Inventors: Frederick Lee Kitson, Livermore, CA (US); Marc P. Schuyler, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/908,598

(22) Filed: Jul. 20, 2001

(51) Int. Cl. H04M 1/00

(52) U.S. Cl. 455/566; 455/550; 455/414

(57) ABSTRACT

A wireless communication system is disclosed for communicating via a broadcast signal and a dedicated telephone connection. A remote wireless device has a broadcast receiver for receiving a locally broadcast signal from a broadcast unit. The device can be a cellular telephone with a local access function. The continuously looping signal can be transmitted for local access only (e.g., within a building) and contains a start signal, display information, and command information for a plurality of for a plurality of related, hierarchical menus. A broadcast receiver processing unit of the device converts the signal into one or more text menus for display on the wireless device. The menus may be navigated using an input device, and various branches within the hierarchical menu structure can be used to enable wireless users to focus in on items of interest. One embodiment of the device permits use of the menu structure for assisting with commercial transaction; for example, individual menu entries may include transparent commands that cause the cellular telephone to format an electronic transaction request, to dial a specific telephone number, and to effectuate the transaction.

### FIELD OF INVENTION

The present invention relates generally to wireless communication systems. More particularly, it relates to a system and method for broadcasting textual or character information to one or more wireless devices.

### BACKGROUND

In the field of communication it is often desirable to disseminate information to a large audience. Generally, radio frequency broadcasts have proven extremely useful for meeting this need. Unfortunately, broadcasts of this type are not well suited to disseminating varied information where broadcast recipients may have needs for different information; for example, broadcasts of product advertisements typically are cost-justified only when the broadcast reaches a sufficient number of recipients who are receptive to the particular advertisements. Furthermore, even if there is an item of widespread interest in a broadcast, an interested user is typically required to sift through other, irrelevant information before finding the information of interest. Generally, the more information broadcast, the less likely it is that an interested user will obtain specific information contained in a broadcast.

Use of the Internet has recently facilitated quick access by many users to specific sets of varied information; for example, a person desiring to attend a new cinematic release may often electronically research complete details on movie-times and featured films. Unfortunately, use of the Internet in this manner typically requires that an interested user first have an Internet connection and suitable hardware and, second, that the user then research and access a specific web site via a point-to-point Internet connection. The limitations of a point-to-point transmission and the requirements of an Internet connection have typically not been readily adapted to broadcasting information to potentially interested users, particularly those users located in a geographic vicinity (e.g., in a location where they are unlikely to have access to modems and computer workstations).

Still more recently, “beacon” technology has been developed which enables local area transmission of a Uniform Resource Locator (“URL”) for accessing a web page tied to a specific location. For example, such “beacon” technology may be used by a business to transmit a web site for the business, such that people physically passing by a retail establishment may be automatically directed to a web site associated with the store. While taking advantage of a general trend toward widespread acceptance of wireless devices (e.g., cellular phones with Internet capability), such systems still call for an Internet connection and present no effective means for broadcast of large quantities of information that a potentially interested user may navigate and browse. For example, it would be useful to broadcast information that a multitude of local users could access based upon need and interest, and that would enable an interested user to focus and obtain still more detailed information as appropriate.

There is a definite need for a broadcast system that provides information to a multitude of users; ideally, such a system would take advantage of a general trend toward widespread acceptance of wireless electronic devices, such as beepers, personal data assistants, cellular telephones and other devices. Still further, a need exists for a system that permits broadcasts having varied information, yet enabling interested recipients to quickly navigate to specific detailed information of interest. If such a system existed, it might facilitate the offering of products and other information, thereby having applicability to commerce. Further still, a need exists for a local access system that, much like the “beacon” system alluded to above, provides ability to broadcast and receive locally pertinent information. The present invention satisfies these needs and provides further, related advantages.

### SUMMARY OF INVENTION

The present invention provides a wireless communications system that permits broadcast of information via a menu structure embedded in the a broadcast signal. The menu structure may be used to communicate a broadcast signal to a multitude of wireless device users capable of receiving such a signal, for example, as part of a local access channel. The present invention thus facilitates a broadcast that may be used to assist with commercial transactions or otherwise to distribute a variety of information simultaneously to users with different interests. Through preferential use of a hierarchical menu structure, users receiving the wireless broadcast may independently navigate the menu structure to “focus” on particular items of interest.

The present invention also discloses a wireless device, broadcast system, and method that are analogous to or compatible with the operation of the wireless communications system. Various forms of the invention may include almost any type of remote wireless device, and through the use of the menu and signal structure disclosed hereby, the display capabilities commonly found on almost any variety of conventional digital device (e.g., beepers, watches, cellular telephones, personal data assistants, and other devices) may be controlled to present a menu structure as contemplated part of the present invention.

The invention may be better understood by referring to the following detailed description, which should be read in conjunction with the accompanying drawings. The detailed description of a particular preferred embodiment, set out below to enable one to build and use one particular implementation of the invention, is not intended to limit the enumerated claims, but to serve as a particular example thereof.

### SUMMARY OF DRAWINGS

FIG. 1 shows a block diagram of the communication system.

FIG. 2 shows a more detailed block diagram of the system of FIG. 1.

FIG. 3 shows a wireless device having a display.

FIG. 4 shows the wireless device of FIG. 3 with a display of the menu selected in FIG. 3.

FIG. 5 shows the wireless device of FIG. 4 with the menu selection shown in FIG. 4.

FIG. 6 shows the wireless device of FIGS. 3-5, illustrating the transaction feature of the device.

FIG. 7 shows an alternative embodiment of the wireless device in the form of a watch.

FIG. 8 shows an example of a looping program that includes menu information.

FIG. 9 shows a flow chart of the communication method used by a broadcaster.

FIG. 10 shows a flow chart of the communication method used by the wireless device.

### DETAILED DESCRIPTION

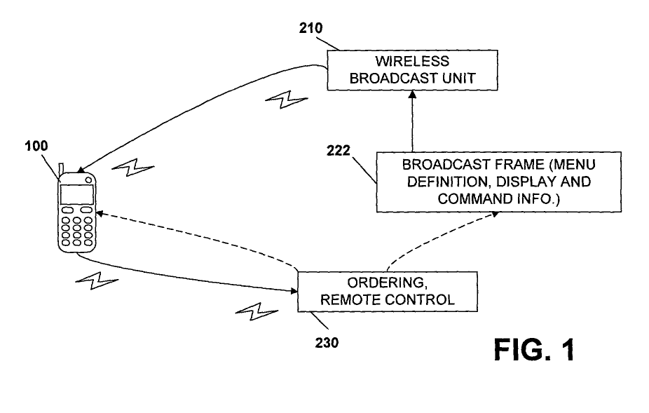

FIG. 1 shows a wireless device 100 that receives a broadcast signal from a wireless broadcast unit 210. The broadcast signal carries menu information 222 defined by a broadcast frame. The broadcast frame includes display information that is to be transmitted to and displayed upon the wireless device 100 and it also contains command information that defines menu organization and may also include other commands as will be discussed further below. The menu information may be any type of information to be transmitted to wireless device users, and may be for example, local broadcast information of high relevance to a geographic vicinity. To provide a few examples, broadcasts from a particular retail establishment may include information about various products offered; broadcasts within a movie theatre may include information about movies shown; broadcasts to motorists on a highway may include information about congestion on various alternative routes.

Using a menu structure, transmitted information is adapted for display on a wide variety of wireless devices having potentially different display capabilities. Additionally, as such information is organized according to one or more hierarchical menus, a wireless device user may navigate such menu or menus to “focus” upon pertinent information of interest. Adding to the hypothetical examples presented above, a broadcast from a retail establishment may identify location within the establishment of specific wares, or may advertise specific “sales;” a movie theatre may provide information sorted through menus by movie, and allow wireless device users to focus upon movie times and ticket availability for specific user selected movies; a broadcast relating to road conditions may permit a wireless device user to navigate through menus to identify a particular route of interest and to focus upon travel conditions associated with that route. In one embodiment of the broadcast system, the broadcast may be an “indoor-only” broadcast; in another embodiment, the broadcast may be intended as an outdoor broadcast covering a fairly large geography. In yet another embodiment, the broadcast frame is repeatedly and continuously transmitted, enabling quick update of transmitted information through update of the broadcast frame transmitted by the wireless broadcast unit.

The broadcast signal is received by the wireless device 100 and may be stored in a memory (not shown in FIG. 1) of the wireless device 100 and displayed on a display of the wireless device 100. The broadcast signal is organized, responsive to information embedded in the broadcast signal, into the one or more hierarchical menus which are then selectively displayed on the wireless device 100. In one embodiment of the wireless device 100, a user interface is utilized by the wireless device user to navigate through menus and to influence the display of a selective one of the hierarchical menus. For example, the broadcast signal may identify a root menu that is automatically displayed in a local access mode of the wireless device; a user of the wireless device can operate the user interface to select other menus and otherwise navigate through a tree structure of menus defined by the broadcast signal.

Another embodiment of the wireless device 100 has the ability to establish a separate connection, for example via a telephone link, upon selection by a user. Based on information received from the broadcast unit 210, the wireless device 100 can use its telephone link to contact the telephone interface 230 where ordering and remote operations may be controlled. The wireless device 100 of such an embodiment includes two separate antennae. One antenna receives the broadcast signal. The other antenna may be a standard antenna used on a cellular telephone or other wireless device for communicating via a network using a dedicated link. More detailed features of this embodiment permit the wireless device to dial a telephone number responsive to selection of a particular menu item by the wireless device user. For example, command information embedded in the broadcast signal may include a telephone number that is automatically dialed responsive to a specific menu selection by the wireless device user. In another, more refined embodiment, other command information in the broadcast signal may cause the wireless device 100 to format a transaction request based upon menu selections. For example, the wireless device through menu navigation may be caused to format a specific list of desired purchases, and through menu selection of a purchase decision, the wireless device may cause the dialing of a telephone number to initiate a transaction request responsive to the specific list.

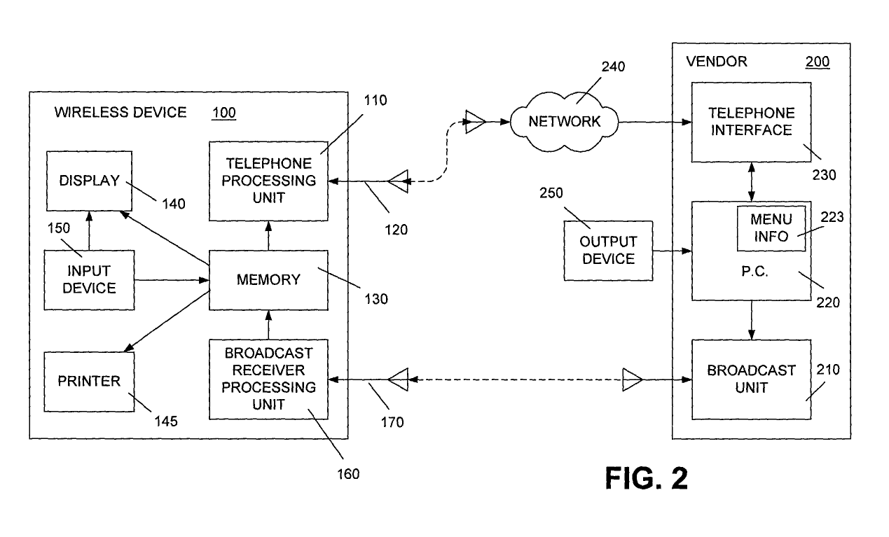

FIG. 2 shows a more detailed block diagram of the system shown in FIG. 1. The wireless device 100 of the embodiment of FIG. 2 is adapted not only to receive broadcast signals but also to establish a second connection via a telephone link. This embodiment of the wireless device 100 enables a wireless device user to select a feature from a menu broadcast by the broadcast unit 210, to receive a user selection from the broadcast menus, and to process a transaction via the separate telephone link based on the selection. The wireless device 100 has a telephone processing unit 110 connected to a telephone antenna 120. The telephone processing unit 110 is also connected to a memory 130 that stores ordinary telephone information and that may also store menu information described herein. The wireless device 100 has a user interface including an input device 150 (which may be the telephone controls in the example of the cellular telephone 100). The input device 150 and the memory 130 are also connected to a display 140. In the example in which the wireless device 100 is a cellular telephone 100, the display 140 may display alphanumeric information stored in the memory 130, such as telephone numbers stored in a list. The embodiment of the wireless device 100 shown in FIG. 2 also includes a printer 145 connected to the memory 130 for printing information. The telephone processing unit 110, the telephone antenna 120, the memory 130, the display 140, and the input device 150 may also be existing elements in a conventional cellular telephone 110. As some conventional cellular telephones feature multiple modes, e.g., provide the ability to play games or view a call log, one embodiment of the wireless device 100 allocates the viewing of menu information according to the present invention as part of a “local access” mode that may be implemented on a cellular telephone.

The wireless device 100 also includes a broadcast receiver 170 connected to a broadcast receiver processing unit 160. The broadcast receiver processing unit 160 is in turn connected to the memory 130. The receiver 170 receives a signal from a broadcast unit 210. The signal 300 may be a continuous looping signal, such as the signal shown in FIG. 8 herein. The broadcast receiver processing unit 160 processes the signal that is received and may store all or part of the signal 300 in the memory 130. In local access mode, the wireless device 100 may display a menu 330 retrieved by the broadcast receiver processing unit 160 from the broadcast unit 210 on the display 140. The menu 330 may be navigated using the input device 150. The broadcast unit 210 may be part of a broadcaster 200, such as a vendor 200, that broadcasts local information. The broadcast unit 210 may send its signal using any number of conventional methods, including but not limited to radio frequency signals, microwave signals, infrared signals, etc. In one embodiment, the broadcast unit 210 is designed for intra-building communications, and communicates the broadcast signal via a low power radio frequency signal.

The broadcast unit 210 may be connected to a personal computer 220 that provides menu information 223. The menu information 223 may be stored in a software program residing in the computer 220. The computer 220 may be controlled by a user of the vendor to input and update menu information 223. In one embodiment, the computer 220, or other menu generation means 220, includes software that prompts the broadcaster 200 to input a number of menu items and information related to those items, which is used to create the menus. This software preferably through the use of easy to understand textual questions acquires all information to be included in the broadcast frame, and it then compiles such information into the broadcast frame, representing display information as well as command information. The broadcast unit 210 receives information from the computer 220 and broadcasts it within a designated area.

In one example, the system may be used to complete a transaction using both the broadcast unit 210 and a telephone interface. In such an example, the wireless device 100 receives information via its broadcast receiver 170, it allows the user of the wireless device 100 to select a transaction using the input device 150, and it then processes the transaction using the existing telephone processing unit 110 and the existing telephone antenna 120 to contact the vendor 200. In this example, the user of the wireless device 100 makes a selection to complete a transaction. The wireless device 100 may then automatically cause the telephone processing unit 110 to connect to the vendor using a dedicated link through the telephone antenna 120. In one embodiment, the vendor's telephone number or numbers are transmitted to the wireless device 100 as part of the broadcast signal. The broadcaster's telephone numbers may be transparent to the user of the wireless device 100, for example by including it only in command codes that are not displayed on the wireless device 100. The vendor 200 may include a telephone interface 230 having a modem line or other telephone connection connected to a telephone network 240 that can receive phone calls, including wireless phone calls from the wireless device 100. Using the user's selections on the input device 150, the wireless device 100 knows what transaction the user of the wireless device 100 intended to make with the vendor 200.

The wireless device 100 transmits the request via the telephone antenna 120 through the network 240 to the telephone interface 230 of the vendor 200. The vendor 200 may then respond through its telephone interface 230 to consummate the transaction. In one embodiment, the vendor 200 may send the wireless device 100 a confirmation number, pass code, or similar indicator showing that the transaction has been completed, or giving the user of wireless device 100 sufficient information to complete the transaction in person. To provide one hypothetical example of such an operation, a movie-goer may utilize a menu structure to select a particular movie, show time, number of desired adult tickets, and a number of desired child tickets; using a confirmation function such as just described, the user may automatically relay all order information electronically to the movie theatre with the result that when the user arrives at a ticket window the user need only present the confirmation number and make payment, thereby speeding the overall transaction and potentially reducing risk of error. In another embodiment, the memory 130 of the wireless device 100 stores or receives credit card information about the user of the wireless device 100. This credit card information may be pre-stored in the wireless device 100 or entered “live” via the input device 150 in response to a displayed query through the telephone connection. The availability of credit card information enables the vendor 200 and the wireless device 100 user to consummate a purchase transaction via the wireless link, such as a transaction for the purchase of movie tickets. In this example, the vendor 200 may have an output device 250 either as within the vendor 200 or at an outside terminal or kiosk 250. The output device 250 may output the actual movie tickets to the user of the wireless device 100 upon receiving the entry of the confirmation code sent from the vendor 200 to the wireless device 100 previously. Alternatively, the transaction may not be consummated via the wireless link but may instead still include the output of a receipt or other confirmation number using an output device 250, such as a kiosk in a movie theater lobby. The user of the wireless device 100 may enter its code into the output device 250 and may receive back a receipt for the purchase of movie tickets. Alternatively, the output device 250 may receive the confirmation code and may also accept a credit card number or may receive the swipe of a credit card to complete the transaction. When the transaction is consummated with the output device 250, the output device 250 may output tickets to the user. In yet another embodiment, such as that shown in FIG. 2, the wireless device 100 includes a printer 145 and receives printing information that allows it to directly print the subject of the transaction, e.g., theatre tickets that may be used to gain admission. That is to say, in the example of a movie theater vendor, the wireless device 100 may print an actual movie ticket.

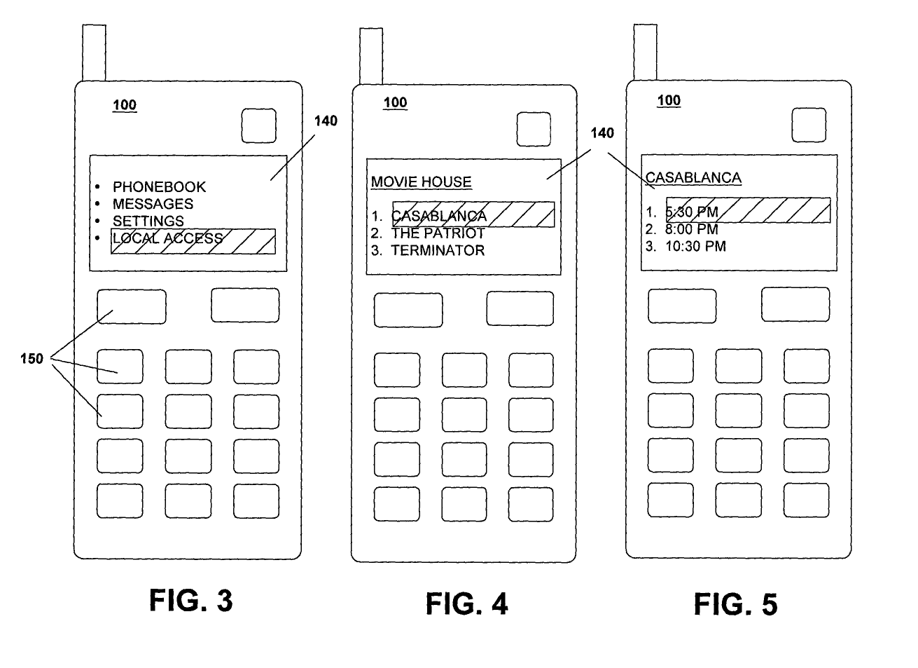

FIG. 3 shows a wireless device 100 having a display 140, and a user interface including input devices 150. The input devices 150 may be existing buttons on a cellular telephone 100, for example. The display 140 shows textual or other character information for the menu processing system and for other functions. In one embodiment, the wireless device 100 may be a wireless telephone 100 having functions for both telephone communications and for local access functions described herein. A user may use the input devices 150 to select a local access function from the display 140.

FIG. 4 shows the wireless device 100 of FIG. 3, using the local access broadcast function. The wireless device 100 displays a menu or multiple functions, including a local access function for receiving locally broadcast information. In local access mode, the wireless device 100 displays locally broadcast signals sent by a broadcast unit 210. In one embodiment, the local broadcast unit 210 may operate within a limited area. For example, it may operate within the confines of a building or a stadium, or within a specified range of an outdoor broadcast point. In the example shown in FIG. 4, the local access function is shown to be used near or within the lobby of a movie theater. The display 140 shows information sent by a broadcast unit 210 at the movie theater to display information about movies currently playing in the theater. The movies “Casa Blanca,” “The Patriot,” and “Terminator” are shown in the example of FIG. 4 as being current movies.

FIG. 5 shows the wireless device 100 displaying further information about one of the selected movies. In FIG. 4, the user selected the first movie, “Casa Blanca.” A selected item may be indicated through altering the visual appearance, such as through shading, highlighting, inverse colors, adding arrows or pointers, or providing other indications such as an audible sound. Information is shown on the display 140 in FIG. 5 for the movie “Casa Blanca” and includes movie times. Again, the user may use the input devices 150 to select one of the movie times to navigate to another menu in a hierarchical menu structure to get further information.

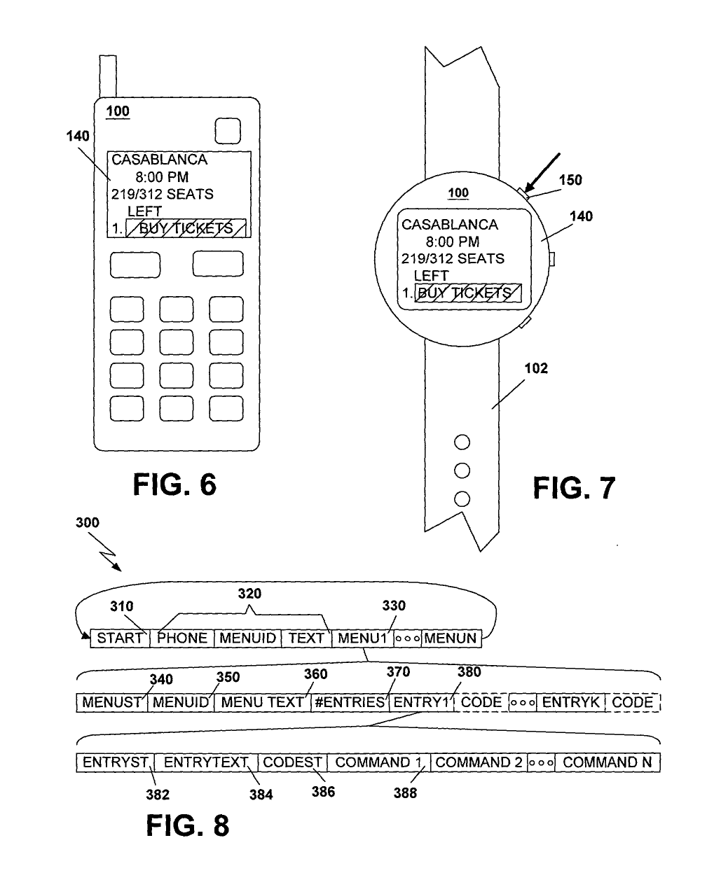

FIG. 6 shows the wireless device 100 having a display 140 shown after use of the input devices 150 to select the 5:30 p.m. showing of “Casa Blanca.” In the example shown of FIG. 5, the user receives information about the 8:00 p.m. showing of “Casa Blanca,” including the number of tickets available at that showing. In FIG. 6, the menu information 222 also includes information that allows the user to purchase tickets for the selected movie.

As mentioned earlier, one embodiment of the broadcast system features use of the broadcast frame in a continuously repeating loop. In such an embodiment, information may be updated almost instantaneously. In the example of FIG. 6, if a movie were to “sell out” while a wireless device user was inquiring about the movie, the broadcast frame could be immediately updated to inform wireless device users that the 5:30 p.m. showing of “Casa Blanca” had “sold out,” and that no more tickets are available for that showing. One embodiment of the wireless device therefore stores menu selection information input to the wireless device by the wireless device user, it searches for and extracts information for the pertinent menu from each receipt of a looping broadcast frame, and it displays the most current information for the wireless device user. The embodiment may also be caused to remember and store information about root menu structure for accessing relatively higher menus in the menu hierarchy, and it also includes exception handling in case root menu information is changed in between two specific broadcast frames.

In one embodiment, such as the embodiment shown in FIG. 2, the wireless device 100 may establish a dedicated link to complete a transaction based on selected menu information. For example, by selecting the purchase tickets option, the user may cause the telephone 100 to automatically establish a cellular link with the movie theater for the purchase of the tickets using a telephone number broadcast as part of the signal. By way of example, the movie theater may then respond via the cellular link to the wireless device 100 with a confirmation number for the purchase of the tickets. The user may then take this confirmation number to the theater to complete the transaction. In another example, the wireless device 100 may store credit card information and may complete the transaction via the wireless link, allowing the user to simply pick up tickets at the window, thereby decreasing the amount of time the user is required to spend in line waiting to purchase tickets. In still another embodiment of the invention, the wireless device 100 may complete the credit card transaction, and may give the user a pass code or other such number that enables the user to enter the theater directly, or to use a kiosk to enter the confirmation code and receive tickets. In yet another embodiment, the wireless device 100 may include a printer for printing a ticket, confirmation code, receipt, or similar item used in connection with the transaction.

FIG. 7 shows an alternative embodiment of the wireless device 100. The embodiment shown in FIG. 7, the wireless device 100 comprises a watch having a display 140, and a user interface including an input device 150. A user may wear the watch 100 using an ordinary watch band 102. As with the cellular telephone 100 shown in FIGS. 2 through 5, the watch embodiment 100 may receive and display text and character menus broadcast by the local broadcast unit 210. The watch embodiment 100 may receive the broadcast signal in the same manner in which the telephone device of the other examples, such as by receiving selected menus from a continuously looping signal The watch embodiment 100 may or may not include a separate telephone or other communication to consummate the transaction. One skilled in the art will recognize that various embodiments of the wireless device may be used and may or may not include a telephone processing unit or other means for connecting to the broadcaster via a separate link.

FIG. 8 shows one embodiment the structure of the broadcast signal 300. For each menu of information to be displayed on wireless devices 100 the signal includes start indicators to indicate the beginning of information related to a particular menu, display information such as text and other character information to be displayed on the wireless device 100, and command information related to the menu. The broadcast signal 300 may be a looping signal controlled by software code, and it may include a start signal 310, initialization codes 320, and information about specific menus 330. The initialization codes 320 may include information used to display the initial menu displayed after the local access function is selected. In one embodiment, the signal 300 is broadcast in a continuous loop. Each menu 330 may have a menu start signal 340 indicating the beginning of a new menu and an identifier 350 indicating to the wireless device 100 the name of the menu for which specific menu information will follow. In the example shown in FIG. 8, the first menu 330 is shown in greater detail having a start indicator 340, an identifier 350, menu text 360, a number of entries 370, and then data for the specific entries 380 in that menu 330. Also the signal data for one of the specific entries 380 is further shown in greater detail. The signal data for one entry 380 an entry start indicator 382 that indicates data for a new entry follows, an entry text code 384 that has text and other character information to be displayed, a command code start indicator 386 that indicates that command codes follow, and various commands 388.

The commands 388 may include any information used by the wireless device 100 to process the signal 300. The commands 388 may be displayed to the user along with the text information 384, or they may be invisible to the user of the wireless device 100. For example, the commands 388 may control how the text information 384 is displayed such as where lines begin and end. The commands 388 may also control how the data is linked to other data in the signal 300, such as how menus are interconnected to jump from one menu to another upon a selection by the user. The commands 388 may also include information used to process a transaction. For example, in the embodiment of FIG. 2 in which the wireless device 100 is capable of establishing a separate connection to perform a transaction, the command codes related to some entries 380 may include a telephone number that is automatically dialed by the wireless device 100 to connect the device 100 to a vendor 200 upon selection by the user. Command codes may in one embodiment also cause the wireless device to automatically and transparently compile a transaction request packet, including information regarding product (such as movie and movie time) and number of requested purchases (such as number of adult and child tickets requested). The command codes may also control a display 140 of the wireless device 100 to display text to the user responsive to menu selection, e.g., a confirmation “Do you want to purchase this amount?”

In use, the broadcast unit 210 may broadcast the signal 300 continuously in a looping fashion. In one embodiment, the wireless device 100 includes a memory that stores the entire broadcast signal 300. The wireless device 100 receives the start signal indicating that it should begin writing the signal 300 to memory. In this embodiment, the memory may be updated periodically to ensure that current information is stored. In an alternative embodiment, the wireless device 100 determines which menu 330 has been selected through the input devices 150 and displays only that menu 330. When a selection is then made from the currently displayed menu 330, the wireless device 100 awaits the next loop of the broadcast signal 300 and again retrieves signal information related to the selected entry 380. Based on command information 388 from the previous menu, the wireless device 100 knows the name or other indicator of the menu selected by the user. When the wireless device 100 receives the start indicator 340 for the selected menu, it begins processing the information that follows for the selected menu and its entries 380. The wireless device 100 may store this information in memory 130. Using the command information 388, the wireless device 100 displays the selected information. This process repeats as the user traverses the menus 330 until the user begins a transaction by making a selection, for example, to purchase something, or until the user exits the local access function. In one embodiment, the wireless device always stores root menu information such that a user may always retrace steps to a menu that is relatively higher in a menu hierarchy.

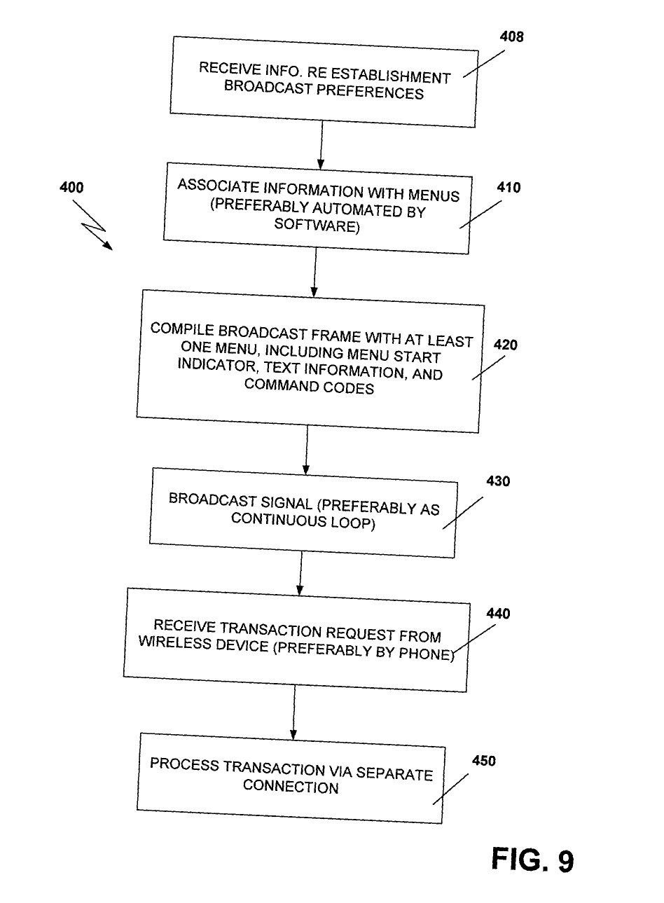

FIG. 9 shows a method 400 of communicating by broadcasting a continuously looping signal having information about menus, as performed by the broadcaster 200. Information is received 408 (preferably via an automated software process) relating to establishment preferences for broadcast. The information is then associated 410 with a plurality of menus to be displayed on a wireless device 100. This association may be performed, for example, using software application that prompts the establishment to enter menu organization information, preferably using easy to understand questions. A broadcast frame is then created 420 having a menu start indicator, menu display information, and command codes associated with the menu text. The broadcast frame is stored in a buffer (not shown) where it is periodically retrieved and broadcast 430 in a continuously looping manner, preferably in a manner that is substantially uninterrupted between re-transmissions. Users of wireless devices 100 receive the broadcast information and preferably, their wireless devices include firmware or software that permit the organization and display of information, as well as the execution of any commands supported by the broadcast signal. For example, users may navigate a menu structure or make transaction requests based upon menu information. A transaction request may be received 440 via a communication link separate from the broadcast signal 300. The request may be received 440, for example, by the broadcaster or its agent. The transaction is processed 450 using the separate link, or another link.

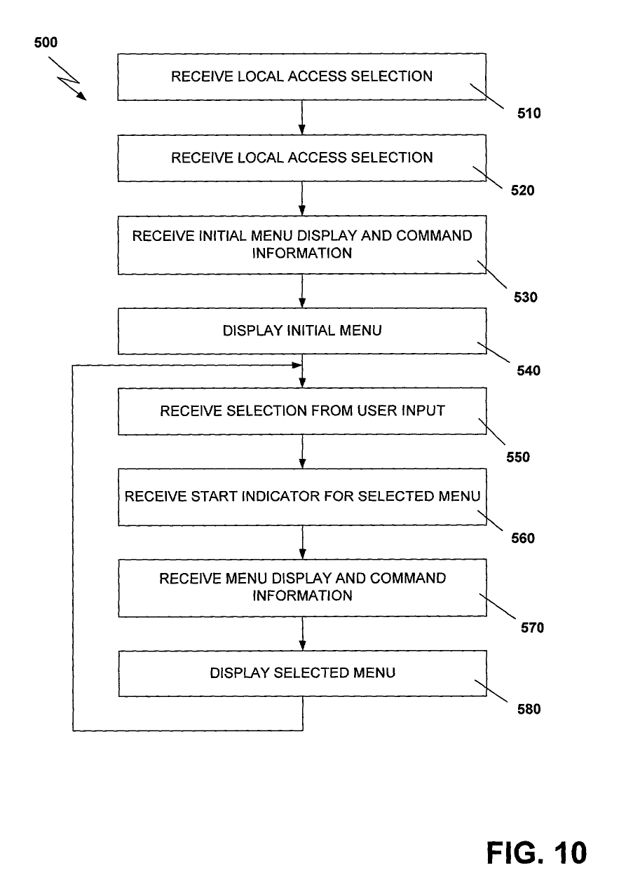

FIG. 10 shows a flow chart of the method 500 for communicating as performed by the wireless device 100 receiving a continuously looping signal 300 having information organized in menus. The wireless device 510 receives a local access selection from a user input device 150. The broadcast receiver processing unit 160 of the wireless device 100 then waits to receive a start indicator from a broadcaster. It then receives 530 initial menu information following the start indicator in the signal 300 and records the pertinent menu information in a memory 130. The wireless device 100 displays 540 an initial menu on a display 140. The wireless device 100 then receives 550 a selection of one of the menu items from the user via a user input device 150. The wireless device 100 waits to receive from the broadcaster a start indicator corresponding to the menu selection received. It then receives further menu text and command information associated with the menu selection. The wireless device 100 then displays 580 a new menu based on based on the menu text information. The menu selection process 500, receipt of start indicator and menu information 560 and 570, and menu display process 580 the repeats as the user of the wireless device 100 traverses menus. In one embodiment, the information received in processes 520, 530, 560, 570 may be stored in a memory 130 in the wireless device 100. In another embodiment, the information may be directly displayed via process 540 or 580 on a display 140, such as on an LCD display 140. In one embodiment, the user may at any time in the process request a transaction supported by the menu information. Upon such a request, the wireless device 100 may initiate a transaction request with the broadcaster 200 as described herein.

Although the present invention has been described with respect to particular embodiments thereof, variations are possible. The present invention may be embodied in specific forms without departing from the essential spirit or attributes thereof. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

1. A wireless communication device comprising:
a broadcast receiver that receives a broadcast signal that contains intermixed display information and sequentially-significant command information;
a user interface;
a broadcast receiver processing unit connected to the broadcast receiver, that separates display information from command information; and
a display controlled by the broadcast receiver processing unit to visually present display information in a menu format responsive to command information;
wherein the user interface permits selective navigation by the user of the menu format.

2. The device of claim 1, wherein:
the display information and command information includes information defining a plurality of hierarchical menus containing text;
the broadcast receiver processing unit causes the display to visually present the user with display information associated with at least one hierarchical menu; and
the user interface permits selective navigation by the user between the hierarchical menus.

3. The device of claim 1, wherein:
the broadcast receiver is adapted to receive command information identifying the format of multiple hierarchical menus, together with display information associated with each menu; and
said device further comprises a memory connected to the broadcast receiver processing unit, that stores at least one hierarchical menu selected by the user, as well as information identifying menu tree structure.

4. The device of claim 3, wherein:
the memory stores display information for at least one hierarchical menu selected by the user, as well as root menu information, and at least one root menu; and
said device is adapted to permit selective menu navigation by the user through user interface selection of a root menu access, and through subsequent interception of a repeated transmission of the broadcast signal including display information associated with a root menu selected by the user for display.

5. The device of claim 1, wherein the broadcast signal contains at least one menu start indicator that identifies of a specific menu, and wherein the broadcast receiver processing unit is adapted to separate display information from command information for a selected menu by receiving the menu start indicator for the selected menu, and identifying ensuing display information in the broadcast signal and identifying ensuing display information in the broadcast signal that precedes another menu start indicator.

6. The device of claim 1, wherein the wireless broadcast signal is broadcast by a local broadcast unit using a continuous looping sequence and includes a broadcast start indicator, display information, and command information for a plurality of menus.

7. The device of claim 1, further comprising a telephone portion having:
a telephone transceiver for sending and receiving wireless telephone signals; and
a telephone processing unit for processing telephonic communication using the telephone transceiver,
wherein the wireless device operates in a telephone mode for transmitting and receiving wireless telephone communications and in a broadcast mode for receiving the wireless broadcast signal.

8. The device of claim 1, wherein the command information includes at least one command that upon user selection of an associated menu item causes the broadcast receiver processing unit to formulate a telephone mode activation and dialing command, and causes the telephone processing unit to execute the telephone mode activation and dialing command, including the dialing of a telephone number contained within command information associated within the user selected menu item.

9. The device of claim 1, wherein said device is a cellular telephone having a local access mode, and wherein said device includes one of software and firmware that causes a display of the cellular telephone to, while in the local access mode, display the menu format and permit selective navigation by the user of the displayed information.

10. The device of claim 1, further comprising a printer adapted for printing information received by the broadcast receiver processing unit.

11. The device of claim 10, wherein the printer is adapted to print tickets.

12. A method of broadcasting from a wireless broadcaster to a plurality of wireless devices, comprising:
associating information with a plurality of hierarchical menus;
creating a signal containing the information, the signal having for at least one of the menus
a menu start indicator,
display information to be displayed on a wireless device, and
command information that identifies menu structure; and
causing the broadcaster to broadcast the signal as a repeating loop.

13. The method of claim 12, wherein the signal contains a menu start indicator, display information and command information for each one of the hierarchical menus, and wherein at least one wireless device includes a user interface, said method further comprising:
causing the command information to identify menu structure for each one of the hierarchical menus; and
using the wireless device to navigate the menu structure and to display a selective one of the hierarchical menus.

14. The method of claim 12, wherein at least one of the wireless devices includes a printer for printing information sent by the wireless broadcaster, the method further comprising sending from the broadcaster to the at least one of the wireless devices information to be printed on the printer.

15. The method of claim 12, further comprising:
receiving a transaction request from a requester based on the information; and
processing the transaction request.

16. The method of claim 12, further comprising receiving a transaction request via a wireless telephone connection where the wireless telephone connection is automatically initiated by user-selection of a menu item using a wireless device.

17. The method of claim 12, wherein the broadcaster is an intra-building broadcaster, and wherein causing the broadcaster to broadcast includes broadcasting within a building using a radio frequency signal.

18. The method of claim 12, wherein the signal includes a menu start indicator, display information, and command information for each of the menus, and wherein broadcasting includes sending the signal as a continuously repeating loop.

19. The method of claim 12, wherein the command information causes the display information at each wireless device to be formatted into a menu of multiple items or services that may be purchased.

20. The method of claim 12, wherein at least one wireless device includes means for selectively displaying one of the hierarchical menus, and means for navigating a menu structure to permit a user of the wireless device to change display by the wireless device to present any one of the hierarchical menus defined by the broadcast signal.

21. A method of broadcasting information to a plurality of wireless devices, comprising:
receiving information regarding establishment preferences for broadcast;
formatting the information into a broadcast frame, where the broadcast frame includes at least one menu adapted for display on one or more wireless devices; and
periodically re-transmitting the broadcast frame;
wherein the broadcast frame includes at least one telephone number adapted to communicate with an establishment representative.

22. The method of claim 21, wherein periodically re-transmitting includes continuously transmitting the broadcast frame as a substantially uninterrupted repeating loop.

23. A wireless communications system, comprising:
a broadcast unit that transmits a continuously looping signal containing information associated with a plurality of menus, which information may be received by a wireless device and displayed on the wireless device as part of a menu structure; and
a cellular telephone having a telephone mode and a local access mode, and having a display and a user interface, the cellular telephone receiving the continuously looping signal while in the local access mode and displaying a selective one of the plurality of menus in response to inputs from the user interface.

24. A wireless communications broadcast system comprising:
a broadcast unit that transmits a continuously looping signal containing information associated with a plurality of menus, which information may be received by a wireless device and displayed on the wireless device as part of a menu structure; and
a receiver for receiving an electronic transaction request via a telephone connection, the request being based on the information transmitted by the broadcast unit and being transmitted by the wireless device.

25. The system of claim 24, wherein the broadcast unit transmits information locally using a radio frequency broadcast.

26. The system of claim 24, further comprising a menu generation means connected to the broadcast unit that associates the information with menus.

27. The system of claim 24, wherein the information includes at least:
a menu start indicator;
display information; and
command information.

28. The system of claim 27, wherein the menus are hierarchical and the command information includes information linking menus within the signal.

29. The system of claim 28, wherein at least one menu item further includes a telephone number for connecting the wireless device to the receiver automatically upon user selection of an associated, displayed menu item using a user interface.
